(19) United States
(12) Patent Application Publication
(10) Pub. No.: US 2008/0128207 A1
(43) Pub. Date: Jun. 5, 2008

(54) DRAIN BOLT

(75) Inventor: John A. Wilkins, Ypsilanti, MI (US)

Correspondence Address: VEDDER PRICE KAUFMAN & KAMMHOLZ, 222 N. LASALLE STREET, CHICAGO, IL, 60601, US

(73) Assignee: SKF USA INC., Elgin, IL (US)

(21) Appl. No.: 11/843,803

(22) Filed: Aug. 23, 2007

Related U.S. Application Data
(63) Continuation-in-part of application No. 11/566,740, filed on Dec. 5, 2006.

(51) Int. Cl. F16C 3/14

(52) U.S. Cl. 184/1.5; 285/321

(57) ABSTRACT

A drain bolt which includes a threaded shank portion, a driving head, and an enlarged primary flange and a pair of secondary circular flanges of reduced diameter with respect to said enlarged flange, said reduced diameter flanges holding a captive O-ring between them. The seal is between a cylindrical counterbore and the O-ring, and is completely independent of the force with which the drain bolt is installed. In other embodiments, there is a drain bolt with a captured washer, allowing limited movement of the washer, and in another embodiment, the drain bolt is coined just below the O-ring.

This is a continuation-in-part of application Ser. No. 11/566,740, filed on Dec. 5, 2006.

### BACKGROUND OF THE INVENTION

The present invention relates to several improved drain bolt concepts, and in particular to drain bolts which includes a threaded shank portion, an O-ring retained in on the bolt for insertion into a cylindrical counterbore and in which the bolts includes driving heads and enlarged flanges which abut the marginal portions of the counterbore formed in the oil pan or other oil-containing opening.

Because of the importance of a removable bolt in an oil pan or the like, many proposals have been made. For example, some plugs or other fittings have been proposed which include a threaded shank portion in place for accommodating an O-ring and a frusto-conical portion of the fitting which mates with the frusto-conical portion of the oil pan or the like. Such high pressure fittings relate to the frusto-conical portion in which an O-ring is compressed to a certain variable extent determined by the tightness fitting. Such a construction is described in U.S. Pat. No. 3,893,487.

A similar construction shown in U.S. Pat. No. 3,933,358, which includes a deformable O-ring subject to being compressed by a fitting to a greater or less extent, depending on the tightness of the fitting.

A similar construction involving the compression of the O-ring in a frusto-conical seat is described in U.S. Pat. No. 5,107,808.

Another form of crankcase drain plug is disclosed in U.S. Pat. No. 5,547,042. Still another patent involving an deformable O-ring is shown in FIG. 4 of U.S. Patent Application publication number 2006/0037427A1.

Another drain plug construction is shown in Application Publication US2006/0054402A1, wherein an O-ring is shown being compressed by a complex structure in a couple of different embodiments.

U.S. Pat. No. 6,752,174 shows an O-ring or the like which is situated somewhat down along the threaded shank portion of what is identified as a safety plug.

Finally, another construction is shown in U.S. Pat. No. 4,938,314. This shows an O-ring situated in a groove, but the groove lies in a slight taper and, the oil drain plug is screwed into a threaded bore in an insert. The insert is used because of the plastic construction of the oil pan.

In none of the above constructions is a drain bolt shown wherein the sealing of the drain bolt takes place entirely independently of the torque with which the drain bolt is installed and the head lies outside of the O-ring(s). In some embodiments, the O-ring is entrapped between one flange and a washer or other formation to immobilize the O-ring.

In view of the shortcomings listed above is, it is object to present invention to provide an improved drain bolt construction.

Another object of the invention is to provide a drain bolt construction which includes a pair of flanges separated by an O-ring grove and located on an upper portion of the drain bolt.

A still further object in one embodiment, is to provide a drain bolt with a threaded shank portion, a pair of spaced apart circular flanges adapted to surround an O-ring, and a right circular cylindrical flange surmounted by a driving head.

Yet a further object of the invention in another embodiment is to provide a drain bolt having a captive O-ring and wherein the O-ring is seated in a smooth cylindrical counterbore and in which therefore there is no relation between the torque applied to the bolt for sealing purposes and the shape or sealing ability of the O-ring.

Another object, in a further embodiment, is to provide a drain bolt wherein the O-ring is entrapped between a shoulder on the drain bolt and a semi-floating washer that will bottom on the base of the counterbore when the bolt is installed.

A still further object uses a drain bolt having a coined shoulder which retains the O-ring during shipping, and which will keep the O-ring positioned below the shoulder with a sealing force independent of the torque on the bolt.

### SUMMARY OF THE INVENTION

According to the present invention, therefore, the drain bolt contains a threaded shank for fitting directly into the oil pan, and a pair of spaced apart circular flanges comprising an O-ring groove, wherein the O-ring is permanently seated. Spaced axially apart and away from liquid being contained is first an O-ring groove, and secondly, an enlarged, preferably circular flange, which in turn is surmounted by a driving head. Thus, the bolt has its shank portion received within a threaded bore, a smooth, circular cylindrical counter bore is provided wherein the O-ring is seated, and an enlarged flange and driving head are also provided. In other embodiments, the O-ring is held by a washer which is placed on the bolt before the threads are rolled on the shank, or the shaft is coined so the O-ring cannot readily be removed from the bolt.

The manner in which the invention achieves its objects and other objects and advantages will become more apparent when considered in connection with the following detailed description of the preferred embodiments of the invention and shown in the accompanying drawings in which like reference numbers indicate corresponding points throughout.

### BRIEF DESCRIPTION OF THE DRAWINGS

FIG. 1 is a perspective view, with a portion broken away, of one form of drain bolt of the invention, including the pair of circular flanges holding a captive O-ring between them and showing an enlarged right circular cylindrical flange surmounted by a driving head;

FIG. 2 is similar to FIG. 1, but showing the drain bolt with a portion broken away, and showing an Allen head socket, without the O-ring in place; and

FIG. 3 is a perspective view, with a portion broken away, showing one form of drain bolt in position of use within an oil pan or like, and showing an alternate optional means for driving the bolt.

FIG. 4 is a perspective view of another embodiment of the drain bolt, washer and O-ring of the invention;

FIG. 5 is a vertical sectional view of the assembled drain bolt, O-ring and washer of FIG. 4 in place in an associated crankcase;

FIG. 6 is a vertical sectional view of a portion of the crankcase without the drain bolt of FIGS. 4 and 5 therein;

FIG. 7 is a perspective view of still another form of drain bolt and O-ring of the invention, showing a part of the bolt having a coined portion;

FIG. 8 is a vertical sectional view showing the form of drain bolt shown in FIG. 7 and a portion of the crankcase in which it is used; and

FIG. 9 is a vertical sectional view of a portion of the crankcase of FIG. 8 without the drain bolt therein.

### DESCRIPTION OF THE PREFERRED EMBODIMENT OF THE INVENTION

The invention can be practiced in several ways, and several preferred embodiments are shown. While not a necessary part of the invention, various drive mechanisms are shown, including a plain hex head, with or without wells or sockets for receiving an Allen wrench, or a head portion that accommodates a Phillips head screw driver a Torx fastener or the like.

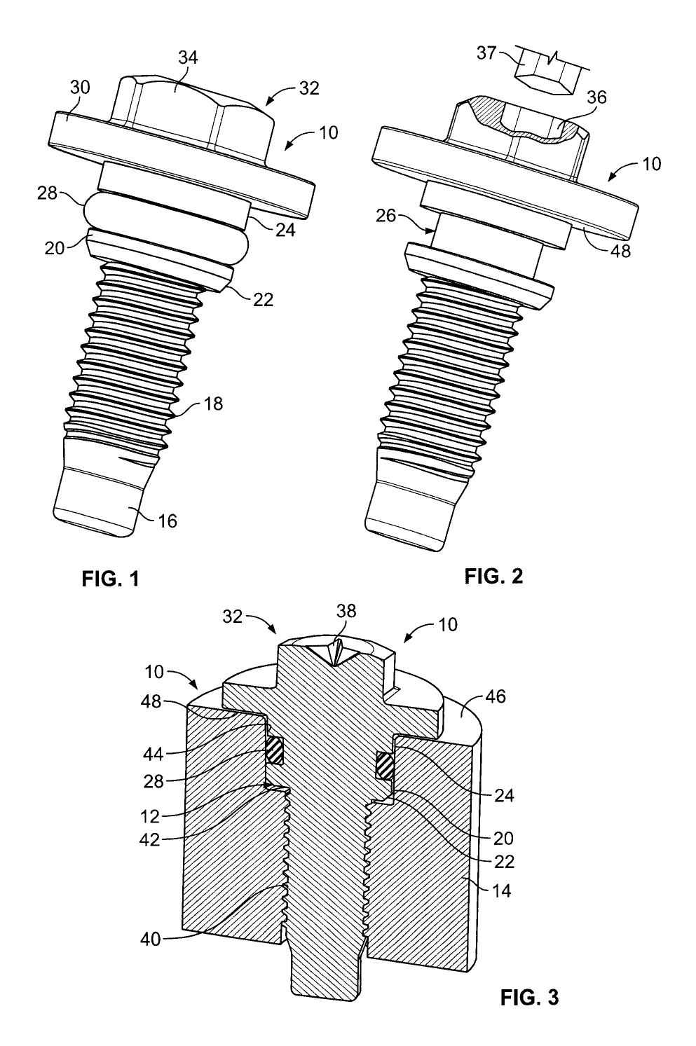

Referring now to the drawings in greater detail, FIG. 1 shows a drain bolt generally designated 10 adapted to be received within an opening generally designated 12 in a portion of an oil pan 14. The bolt includes a lower, entry portion 16, a lower threaded shank portion 18 and a lower circular flange 20 having an optional bevel 22 therein. The circular flange 20 is spaced apart from the substantially identical upper circular flange 24, with the space 26 (FIG. 2) retaining a snugly engaged O-ring 28.

Lying above the upper circular flange 24 is an enlarged right circular cylindrical flange 30. Surmounting the flange 30 is a driving head generally designated 32. The driving head 32 has six flanks 34, arranged in a hex pattern. Other formations, such as a 12-point head, may also be provided, of course.

Such a head 32 may have other or additional driving means, such as a well or socket 36 for accommodating a hex head Allen wrench 37, or having such sides arranged in patterns such as those used by a Torx fastener or the like. The opening 38 in FIG. 3 may also accommodate a Philips head screwdriver or wrench in addition to using the surfaces afforded by the flanks 34.

The oil pan 14 includes an opening for receiving the fastener 10 including a threaded interior bore 40, a step 42, and a smooth counterbore 44 extending axially and ending in a flat exterior margin 46. The margin 46 abuts the lower surface 48 of the flange when the bolt is fully installed.

Upon initially preparing to install an O-ring over the drain bolt, the O-ring is preferably coated with a Teflon™-containing fluorocarbon lubricant or the like. The O-ring may be dipped in the lubricant or the lubricant may be sprayed on, depending on the desire of the user. The application of such a lubricant in some other way would also be satisfactory. Once the bolt is placed in use, oil will inherently coat the O-ring sufficiently and no further steps relative to lubrication need be taken when the drain bolt is removed and reinstalled.

Accordingly, the main advantage of drain plugs such as those described is that the torque or twisting movement with which they are installed has no bearing whatsoever on the degree of sealing. Thus, if the radial force with which the O-ring bears on the groove 26 and the counterbore 44 is sufficient, then the axial force which is generated by the bolt—and however tight it may be—is completely independent of this sealing force. This is, of course, provided that the face 23 of the lower cylinder is always spaced from the surface 42, then the torque will be generated entirely by the resistance between surfaces 46, 48.

The enlarged cylindrical flange 30 is shown as being orthogonal. Of course, if the flange 30 were frusto-conical, then the mating surface 46 should also be inclined to the same degree.

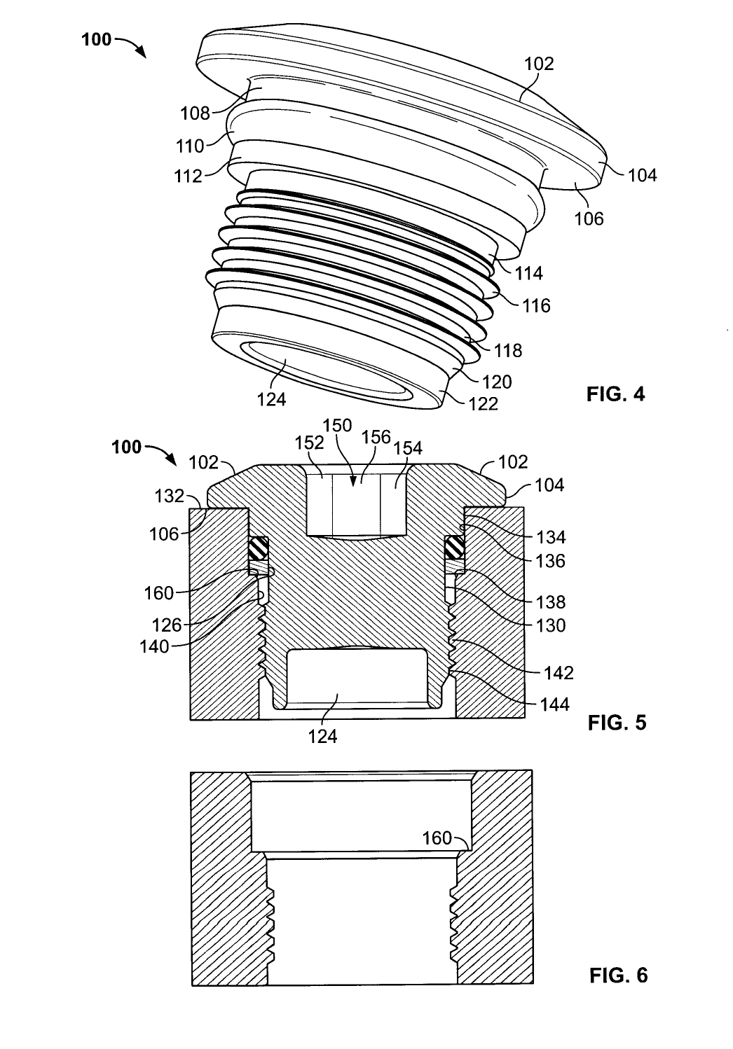

Referring now to FIGS. 4-6, another embodiment of the invention is shown. This embodiment shows a drain bolt generally designated 100, having an enlarged head portion 102 with a cylindrical or rounded edge 104, and a flat face 106. A cylindrical surface 108 lies beneath the face 106, and there is room for an O-ring 110 which lies beneath the cylindrical portion 108, and the flat washer 112.

Beneath the washer 112 is a portion of the shank 114, and threads 116 covering most of the shank portion 118 of the bolt. The bolt 100 may include a tapered bottom portion 120, and a reduced diameter cylindrical portion 122. A pocket 124 for magnetic material may be provided if desired.

A novel feature of the present invention is that the washer 112 is placed over the shank of the bolt and towards the uppermost portion thereof and held in that place before the threads 116 are rolled on the shank portion 118 of the bolt. In this way, the inside diameter of the washer 126 is just more than the unthreaded portion 130 of the shank. Thus, the inside diameter 126 of the washer is such that it will not allow itself to be removed from the bolt, because the threads 116 which are rolled on the shank 118 of the bolt become larger diameter during threading than the opening in the washer. Thus, the washer cannot be removed, and the assembly can be used multiple times.

The lower surface 106 of the head portion matches the flattened portion of the oil pan 132. The oil pan also has a chamfered portion 134, a cylindrical entrance portion 136, and an inclined portion 138 as well as a cylindrical portion or reduced diameter 140. The lower portion of the receptacle 142 is formed with threads 144 with which the threads 116 on the bolt engage.

The well 150 is shown to be provided with opposed flat surfaces 152, 154, 156 in a hexagonal pattern to accommodate an Allen wrench, for example, but other formatives may be used.

In use, the groove for the O-ring is shaped by having the flat portion 160 engage the flat washer and thus confine the ring. The opposed surfaces 106, 132 limit the travel of the bolt 100 in the bore.

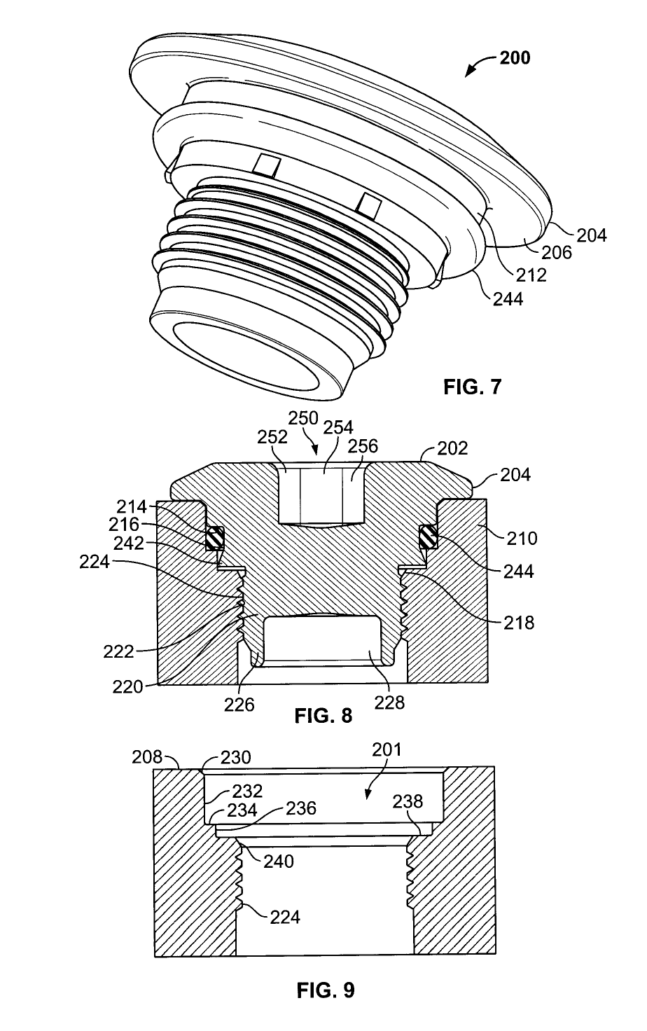

Referring now to FIGS. 7-9, a further embodiment of the invention is shown. Here, a drain bolt generally designated 200 has a head with a crown portion 202, a cylindrical or rounded outer edge portion 204, and a lower surface portion 206. The lower surface portion 206 engages the spot face portion 208 of the oil pan or like structure 210. In addition, the drain bolt includes an upper outside diameter 212, an upper shoulder 214, an intermediate reduced diameter cylinder 216, a lower shoulder 218 as well as a shank portion 220 having threads 222 which engage the threads 224 on the pan 210.

The bolt 200 may have a lowermost, reduced diameter portion 226 defining a pocket 228 for receiving a magnet or the like.

The oil pan 210 may also have an uppermost inclined margin 230, a first bore 232, a first shoulder 234, a counterbore 236, a second shoulder 238 and an inclined lower margin 240 leading into the threaded portion 224.

One important feature of this embodiment is that there are a number—preferably six—of small formations 242 formed by coining the reduced diameter cylinder 216 very slightly. These formations 252 enable the O-ring 244 to be retained during handling on the bolt 200. As a result, the O-ring 244 cannot be readily stripped from the bolt 200.

The bolt 200 may have any kind of head on it, the illustration showing a well generally designated 250 having hexagonal sidewalls 252, 254, 256. Other forms of well or the shape of the outer edge 204 the like may be formed in an appropriate manner for the same purpose.

When the bolt 200 is placed in the opening 201 and tightened down, the O-ring is initially held in place by the coined formation 242, the travel of the head is limited by engagement of the faces 206, 208, while the O-ring is finally held in the channels formed by surfaces 212, 214, 232, 234.

It will thus be seen that the present invention provides a number of forms of oil pan drain bolt each having a number of advantages and characteristics, including those pointed out above and others which are inherent in the invention.

What is claimed is:

1. A drain bolt adapted to create a seal for an oil receptacle or the like, said oil receptacle having a threaded region, a smooth cylindrical counterbore extending outwardly from said threaded region and terminating in a first radially extending surface, said drain bolt comprising, in combination, an axially lower, threaded shank portion, an uppermost, driving head portion, and lying immediately beneath said driving head portion, a cylindrical primary flange of a given diameter, and beneath said primary flange a pair of cylindrical flanges of reduced diameter relative to the diameter of said primary flange and enlarged diameter relative to said threaded shank portion, said two circular flanges being spaced apart so as to provide a radially extending groove therebetween for receiving an elastomeric O-ring serving as a seal between said bolt and a counterbore spaced from said circular flanges by a working clearance, said bolt providing a sealing force entirely independent of the torque applied to said head portion.

2. A drain bolt as defined in claim 1 wherein said driving head portion is hexagonal in shape.

3. A drain bolt as defined in claim 1 wherein said driving head portion is square in shape.

4. A drain bolt as defined in claim 1 wherein said driving head portion includes a Phillips head portion.

5. A drain bolt as defined in claim 1 wherein said driving head portion is a socket for receiving an Allen wrench.

6. A drain bolt as defined in claim 1 wherein said primary flange lies in a flat plane.

7. A drain bolt as defined in claim 1 wherein said shank portion includes a lowermost entry portion free from threads.

8. A drain bolt adapted to create a seal for an oil receptacle or the like, said oil receptacle having a threaded region, a smooth cylindrical counterbore extending axially outwardly from said threaded region and terminating in a first radially extending surface, said drain bolt comprising, in combination, an axially lower, threaded shank portion a cylindrical surfaces, an uppermost, driving head portion, and lying immediately beneath said driving head portion, a pair of cylindrical surfaces, one of which is of enlarged diameter relative to said threaded shank portion, said drain bolt also including a washer having an inside diameter smaller than the diameter of said threaded portion of said bolt, and an elastomeric O-ring entrapped between said washer, said shoulder, said counterbore and said surface of enlarged diameter.

9. A drain bolt adapted to create a seal for an oil receptacle or the like when installed, said oil receptacle having a threaded region near one axial end thereof, a stepped, smooth cylindrical counterbore extending axially outwardly from said threaded region and having axially spaced apart, first and second radially extending axially outermost surfaces, and a flat, radially extending surface, said drain bolt comprising an axially lower, threaded shank portion, a stepped shaft portion, and an uppermost, driving head portion, and lying immediately beneath said driving head portion, a cylindrical primary flange of a given diameter, less than the diameter of driving head portion, and beneath said primary flange, a second cylindrical flange of reduced diameter relative to the diameter of said primary flange and enlarged diameter relative to said threaded shank portion, said two flanges being adjacent one another and providing a pair of shoulders for receiving an elastomeric O-ring there-between, said second shoulder having a plurality of radially spaced apart formations formed by coining, said coined formation retaining said O-Ring in place adjacent said first shoulder prior to completing said installation.
